(19) United States
(12) Patent Application Publication
(10) Pub. No.: US 2025/0349012 A1
(43) Pub. Date: Nov. 13, 2025

(54) Method and Apparatus for Generating Cutting Trajectories for Segmenting Targets in Medical Imaging

(71) Applicant: Beijing Anzhen Hospital, Capital Medical University, Beijing (CN)

(72) Inventors: Yuanhan Mo, Beijing (CN); Lei Xu, Beijing (CN); Zhen Zhou, Beijing (CN); Xiang Li, Beijing (CN); Yike Guo, Beijing (CN); Fangde Liu, Beijing (CN); Guang Yang, Beijing (CN); Xiaoping Fan, Beijing (CN); Shuo Wang, Beijing (CN)

(73) Assignee: Beijing Anzhen Hospital, Capital Medical University, Beijing (CN)

(21) Appl. No.: 18/660,470

(22) Filed: May 10, 2024

(51) Int. Cl. G06T 7/11; G06T 7/00

(52) U.S. Cl. CPC G06T 7/11; G06T 7/0012; G06T 2207/10088; G06T 2207/10116; G06T 2207/30048; G06T 2207/30088

(57) ABSTRACT

The present disclosure relates to the field of computer vision technology and provides a method and apparatus for generating cutting trajectories of medical image targets. The method includes: obtaining a target image to be processed, which includes chest X-ray images, cardiac MRI images, and dermatoscope detection images; selecting an initial point of the target image and using it as the starting point for a navigation agent; and guiding the navigation agent to generate trajectory points until a cutting trajectory containing the target to be segmented is generated. Based on the generated trajectory points and the sampling areas corresponding to each sampling operation, real-time calculation is used to determine the deviation of each sampling. The method also includes correcting the sampling direction, generating cutting trajectories on the target image, and optimizing the generated cutting trajectories to obtain a target image containing the segmented target.

### TECHNICAL FIELD

This present disclosure relates to the field of computer vision technology, specifically focusing on a method and apparatus for generating cutting trajectories for segmenting targets in medical imaging.

### BACKGROUND

The application of deep learning in medical image segmentation is an important advancement in the intersection of medical imaging and artificial intelligence in recent years. This technology utilizes complex neural network models, especially Convolutional Neural Networks (CNNs), to automatically identify and segment specific structures in medical images, such as organs, tumors, or other physiological features.

While current methods have achieved a certain level of segmentation accuracy, they still face the following issues. The generated segmentation boundaries are not smooth enough, and after extracting pixel information from the rectangular region around their positions, trained neural networks are typically directly utilized to predict the next displacement. However, this prediction process is independent of the previous displacement, resulting in insufficiently smooth trajectories in the final result, which in turn affects the accuracy of image segmentation.

Furthermore, by utilizing neural networks to learn the correspondence between image block information and displacement information, the trained neural network can guide the “agent” to move on the image to be segmented. Essentially, this can be understood as a process of numerically solving differential equations. However, such numerical methods typically come with accumulated errors, mainly caused by the differences between discrete and continuous systems. Therefore, there is a problem of low segmentation accuracy due to the introduction of accumulated errors caused by the differences between discrete and continuous systems in neural network methods.

Hence, it is necessary to propose a new method for generating cutting trajectories for segmenting targets in medical images to solve the aforementioned problems.

### SUMMARY OF THE INVENTION

The present disclosure aims to provide a method and apparatus for generating cutting trajectories for segmenting targets in medical images to solve the problem of insufficiently smooth trajectories generated by existing methods, which in turn affects the accuracy of image segmentation, and the problem of the low segmentation accuracy caused by accumulated errors resulting from the differences between discrete and continuous systems introduced by neural network methods. The technical problem to be solved by the present disclosure is achieved through the following technical solutions.

The first aspect of the present disclosure proposes a method for generating cutting trajectories for segmenting targets in medical images, comprising:

Acquiring the image to be processed, which includes chest X-ray images, cardiac MRI images, and dermatoscope detection images, the image to be processed containing target to be segmented of relevant medical anatomical structures.

Selecting an initial point in the image to be processed and using this initial point as the starting point for a navigation agent. The navigation agent guides the generation of trajectory points until a cutting trajectory containing the target to be segmented is created.

Specifically, the method includes:

Sampling each trajectory point to obtain a sampling region (e.g., a square image block extracted from the original image of the image to be processed at the current trajectory point) and inputting the obtained sampling region into a pre-trained deep learning model. This step aims to predict the displacement from each trajectory point to the next, allowing the navigation agent to generate continuous trajectory points that encompass the target to be segmented, forming a cutting trajectory.

Calculating the deviation for each sampling operation in real-time based on the generated trajectory points and the corresponding sampling regions for each sampling operation. This calculation is used to correct the direction of each sampling operation, optimizing the generated cutting trajectory while generating the cutting trajectory on the image to be processed.

Using the optimized cutting trajectory to segment the image to be processed and obtain the target image containing the target to be segmented.

In some embodiments, the method involves selecting an initial point in the image to be processed and performing recursive sampling on this initial point. This includes a predefined number of correction iterations to obtain the displacement corresponding to the corrected initial point. Specifically:

Perform a predefined number of sampling operations on the initial point and adjust the sampling direction of the initial sampling region based on the initial point for a predefined number of iterations to obtain the corrected sampling direction of the initial sampling region.

Perform recursive sampling on each trajectory point that will be formed on the image to be processed and apply a predefined number of correction iterations to obtain the displacement corresponding to each corrected trajectory point.

In some embodiments, when the predefined number of correction iterations is denoted as C, the sampling direction of each trajectory point on the image to be processed is corrected C times. The corrected displacement difference of the current time step t and time step t−i are calculated using the following expression:

$${CDO}_{t} = S ( C ) {\sum }_{i = 1}^{n} {( 1 - S ( C ) )}^{i - 1} Δ {v}_{t - i}$$

Where CDOₜ represents the correction displacement required for the navigation agent at the current time step t on the image to be processed to move from the current trajectory point to the next trajectory point; t represents the current time step; S(C) is a sigmoid function with logarithm, i.e.

$$S ( C ) = \frac{1}{1 + {e}^{log ( C )}} ,$$

used to represent the weight at each time step, C indicating the number of recursive samplings at the same trajectory point; vₜ represents the displacement at a certain time t or the current time step, vₜ₋ᵢ indicating the displacement at time t−i, i is a positive integer, i indicating the number of steps of displacement forward from the current time step t; Δvₜ₋ᵢ represents the difference from vₜ₋ᵢ and vₜ₋ᵢ₋₁.

According to optional embodiments, in the case of the image to be processed being chest X-ray images, the predefined number of recursive sampling iterations C is preferred to be in the range of 5 to 20 times, preferably 15 times. Similarly, for cardiac MRI images, the preferred range for C is also 5 to 20 times, preferably 15 times. In the case of dermatoscope detection images, the preferred range for C is between 10 to 20 times, preferably 15 times.

According to optional embodiments, the displacement from the current trajectory point to the next trajectory point is corrected based on the current time step t corresponding to the current trajectory point and the calculated correction displacement difference CDOₜ:

$${v}_{t}^{′} = {v}_{t} + {CDO}_{t}$$

Where vₜ represents the displacement from the current trajectory point to the next trajectory point; vₜ represents the corrected displacement corresponding to the next trajectory point from the current trajectory point; CDOₜ represents the correction displacement required for the navigation agent at the current time step t on the image to be processed to move from the current trajectory point to the next trajectory point; t represents the current time step.

According to optional embodiments, further steps include the following specifics of recursive sampling:

Step S201: When the navigation agent moves to the current trajectory point, the navigation agent first moves along the direction of the previous displacement and extracts the image block corresponding to the sampling region from the image to be processed, based on the displacement of the previous trajectory point.

Step S202: Input the extracted image block corresponding to the sampling region into a pre-trained deep learning model, outputting a temporary sampling direction. Adjust the sampling direction of the sampling region corresponding to the current trajectory point to align with the temporary sampling direction.

Step S203: Loop through Step S202 for the current trajectory point according to the number of recursive samplings, outputting the temporary sampling direction each time. When the predefined number of recursive samplings is reached, use the last outputted temporary displacement, i.e., the temporary sampling direction, as the movement direction to the next trajectory point and the sampling direction of the next trajectory point.

According to optional embodiments, further steps include determining whether the generation process of the cutting trajectory containing the target to be segmented is completed based on convergence criteria. The convergence criteria include defining a detection line. During the generation process of the cutting trajectory containing the target to be segmented, interval lines are formed based on the intersection points between the generated trajectory line and the detection line. These interval lines are further compared to a preset distance to determine whether the generation process of the cutting trajectory containing the target to be segmented is completed.

According to optional embodiments, it also includes calculating the displacement corresponding to the next trajectory point from the current trajectory point based on the previously generated displacement and the calculated exponential moving average EMAₜ.

$${v}_{t}^{′} = {v}_{t} + {EMA}_{t}$$

Where vₜ represents the displacement from the current trajectory point to the next trajectory point; vₜ represents the corrected displacement corresponding to the next trajectory point from the current trajectory point; EMAₜ represents the correction displacement required for the navigation agent at the current time step t on the image to be processed to move from the current trajectory point to the next trajectory point; t represents the current time step.

The second aspect of the present disclosure proposes an apparatus for generating cutting trajectories for segmenting targets in medical images, utilizing the method for generating cutting trajectories for segmenting targets in medical images as described in the first aspect of the present disclosure. The apparatus includes:

Creation module: Acquiring the image to be processed, which includes chest X-ray images, cardiac MRI images, and dermatoscope detection images, with the image containing target structures relevant to medical dissection.

Sampling operation module: Selecting an initial point in the image to be processed and using this initial point as the starting point for a navigation agent. The navigation agent guides the generation of trajectory points until a cutting trajectory containing the target to be segmented is created.

Specifically, the apparatus includes:

Sampling operation module: Performs sampling operations on each trajectory point to obtain a sampling region (for example, a square image block extracted from the original image at the current trajectory point). Inputs the obtained sampling region into a pre-trained deep learning model to obtain the displacement from each trajectory point to the next, enabling the navigation agent to generate continuous trajectory points that encompass the target to be segmented, forming a cutting trajectory.

Correction module: Calculates the deviation for each sampling operation in real-time based on the generated trajectory points and the corresponding sampling regions for each sampling operation. This calculation is used to correct the direction of each sampling operation, optimizing the generated cutting trajectory while generating the cutting trajectory on the image to be processed.

Cutting module: Segments the image to be processed based on the optimized cutting trajectory to obtain the target image containing the target to be segmented.

The third aspect of the present disclosure provides an electronic apparatus comprising one or more processors and a storage device for storing one or more programs. When the one or more programs are executed by the one or more processors, the processors implement the method described in the first aspect of the present disclosure.

The fourth aspect of the present disclosure provides a computer-readable medium storing a computer program. When the computer program is executed by a processor, it implements the method described in the first aspect of the present disclosure.

The embodiments of the present disclosure have the following advantages:

Selection of Initial Point: The invention selects an initial point in the image to be processed and uses it as the starting point for the navigation agent. This guides the navigation agent to generate trajectory points until a cutting trajectory containing the target to be segmented is created.

Real-time Correction of Sampling Direction: The invention calculates the deviation for each sampling operation based on the generated trajectory points and the corresponding sampling regions. This real-time calculation is used to correct the direction of each sampling operation, optimizing the generated cutting trajectory while generating it on the image to be processed.

Improved Segmentation Precision: The optimized cutting trajectory is used to segment the image to be processed, resulting in a target image containing the target to be segmented. This process enhances segmentation precision and addresses the issue of low segmentation accuracy caused by cumulative errors introduced by neural network methods due to differences between discrete and continuous systems.

In addition, the present disclosure achieves improved segmentation precision by performing recursive sampling on each trajectory point of the image to be processed (i.e., sampling the same trajectory point a predefined number of times). It corrects the displacement (i.e., movement direction or sampling direction) from the current trajectory point to the next trajectory point based on the current trajectory point corresponding to the current time step and the calculated correction displacement. By adjusting the predefined number of recursive samplings according to the application for different medical images, more accurate cutting trajectories for the target can be obtained, leading to further improvement in segmentation precision.

Furthermore, by adjusting the preset distance of convergence conditions for different medical images, it is possible to obtain more accurate cutting trajectories for the target while optimizing the pre-trained deep learning model. This adjustment contributes to further improving segmentation precision.

### BRIEF DESCRIPTION OF THE DRAWINGS

FIG. 1 is an exemplary flowchart of the steps involved in the method for generating cutting trajectories for segmenting targets in medical images according to the present disclosure.

FIG. 2 is a schematic diagram of an example of an image to be processed using the method for generating cutting trajectories for segmenting targets in medical images according to the present disclosure.

FIG. 3 is a schematic diagram of an example of recursive sampling in the method for generating cutting trajectories for segmenting targets in medical images according to the present disclosure.

FIG. 4 is a schematic diagram of an example of the relationship between the sampled region of an image and displacement vectors in an image to be processed using the method for generating cutting trajectories for segmenting targets in medical images according to the present disclosure.

FIG. 5 is a schematic diagram of an example of completion of generating cutting trajectories for segmenting targets in a dermatoscope detection image using the method of image segmentation control according to the present disclosure.

FIG. 6 is a schematic diagram of an example of the calculation of exponential moving averages in the method for generating cutting trajectories for segmenting targets in medical images according to the present disclosure.

FIG. 7 is a schematic diagram of an example of the cutting trajectories generated by applying the method for generating cutting trajectories for segmenting targets in medical images according to the present disclosure.

FIG. 8 is a structural diagram of an example of the device for generating cutting trajectories for segmenting targets in medical images according to the present disclosure.

FIG. 9 is a structural diagram of an example of the electronic device according to the present disclosure.

### DETAILED DESCRIPTION

The present disclosure addresses the aforementioned issues by proposing a method for generating cutting trajectories for segmenting targets in medical images. This method involves selecting an initial point in the image to be processed and using it as the starting point. Sampling operations begin with the initial sampling region generated from the initial point and continue until a cutting trajectory containing the target to be segmented is generated. Based on the displacement information predicted by a pre-trained deep learning model, the method calculates the exponential moving average in real time to determine the deviation for each sampling operation. This deviation is used to correct the direction of each sampling operation, optimizing the generated cutting trajectory while creating it on the image to be processed. The optimized cutting trajectory is then used to segment the image, resulting in a target image containing the target to be segmented. This process improves segmentation accuracy by optimizing the cutting trajectory for the target and addresses the issue of low segmentation accuracy caused by cumulative errors introduced by neural network methods due to differences between discrete and continuous systems.

Furthermore, the present disclosure achieves more precise generation of cutting trajectories by performing recursive sampling on each trajectory point of the image to be processed (i.e., sampling the same trajectory point a predefined number of times). Simultaneously, it implements a predefined number of corrective treatments for the sampling direction of each trajectory point's corresponding sampling region. This capability enables the generation of cutting trajectories with greater accuracy and optimizes the generated cutting trajectories while creating them.

### Example 1

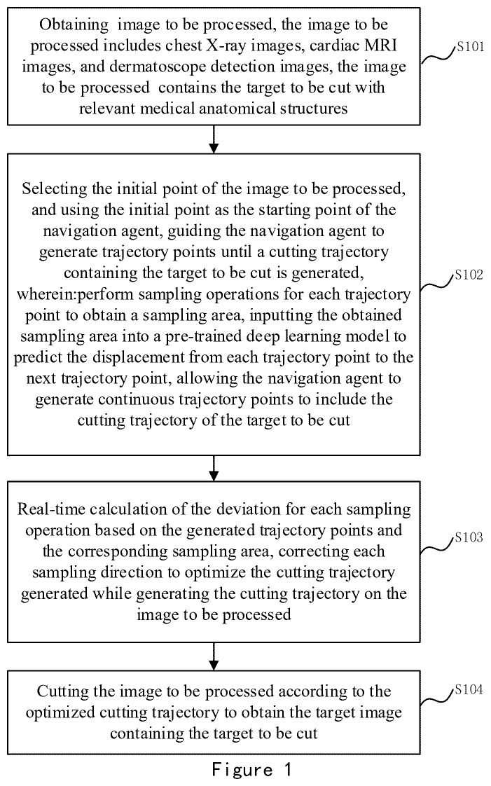

The content of the present disclosure will be described in detail below with reference to FIGS. 1, 2, 3, 4, 5, 6 and 7.

FIG. 1 is an exemplary flowchart of the steps involved in the method for generating cutting trajectories for segmenting targets in medical images according to the present disclosure.

In Step S101 as shown in FIG. 1, the method begins by acquiring the medical image to be processed. The medical image includes chest X-ray images, cardiac MRI images, or dermatoscope detection images, and it encompasses the anatomical structures to be segmented.

For example, obtaining the image to be processed from real-time captures.

Specifically, the image to be processed includes chest X-ray images (specifically containing the heart to be segmented), cardiac MRI images (specifically containing the left ventricle to be segmented), dermatoscope detection images (specifically containing moles to be segmented), and so on.

It should be noted that the above examples are provided for illustrative purposes only and should not be construed as limiting the scope of the invention.

Next, in Step S102, the method selects the initial point of the image to be processed and uses it as the starting point for the navigation agent. This guides the navigation agent to generate trajectory points until a cutting trajectory containing the target to be segmented is produced. Specifically, this includes sampling operations for each trajectory point to obtain sampling regions. These regions are then input into a pre-trained deep learning model to obtain the displacement required to move from each trajectory point to the next, allowing the navigation agent to generate a continuous trajectory containing the target to be segmented.

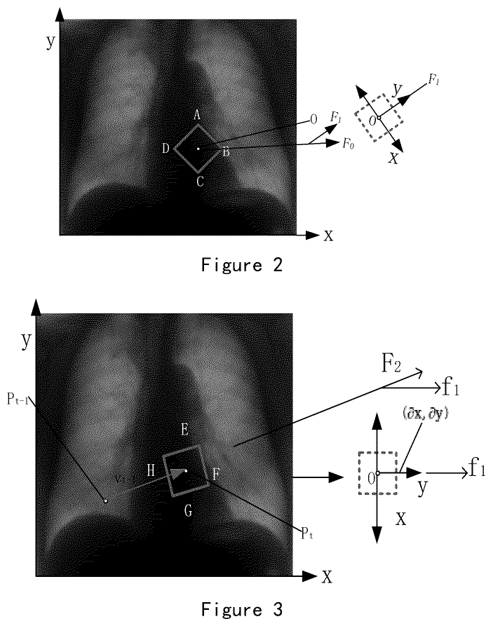

FIG. 2 is a schematic diagram of an example of an image to be processed using the method for generating cutting trajectories for segmenting targets in medical images according to the present disclosure.

In FIG. 2, the method selects the starting point O on a chest X-ray image, which is the initial point of the image to be processed. It then uses point O as the starting point and begins the sampling process using the initial sampling region generated from point O.

To be more specific, a random point (e.g., point O) is chosen on the chest X-ray image as the starting point. This point O serves as the origin, and an initial sampling region (e.g., rectangular region ABCD as shown in FIG. 2) is generated around point O. The orientation of the rectangular region relative to the horizontal or vertical direction forms an angle, which signifies the direction of the next sampling operation for the initial sampling region (i.e., the sampling or movement direction).

Furthermore, sampling operations start from the initial sampling region ABCD generated around the initial point O. Based on the sampling direction determined by the initial sampling region ABCD, the sampling operations for the next time step are guided. This process is repeated to determine the sampling direction sequentially, guiding the navigation agent to generate trajectory points. Specifically, it involves executing sampling operations for the next time step, corresponding to the next trajectory point.

In the first embodiment, recursive sampling is applied to the initial point O, undergoing a specified number of correction processes to obtain the corrected displacement corresponding to the corrected initial point O. Specifically, this involves performing sampling operations for the initial point O a predetermined number of times and adjusting the sampling direction of the initial sampling region based on the initial point O a predetermined number of times to obtain the corrected sampling direction of the initial sampling region.

More specifically, recursive sampling with a specified number of correction processes is applied to each trajectory point to be formed on the image to be processed (including the trajectory point corresponding to the initial point O), resulting in the corrected displacement corresponding to each corrected trajectory point.

Below is an explanation of the recursive sampling process based on the examples shown in FIG. 2 and FIG. 3.

Specifically, recursive sampling involves the following steps:

Step S201: When the navigation agent moves to the position of the current trajectory point, the navigation agent first moves along the direction of the previous displacement and captures the image block corresponding to the sampling region on the image to be processed based on the displacement of the previous trajectory point.

Step S202: The captured image block corresponding to the sampling region is input into a pre-trained deep learning model to output a temporary sampling direction. The sampling direction of the sampling region corresponding to the current trajectory point is adjusted to be consistent with the temporary sampling direction.

Step S203: Based on the number of recursive sampling, the current trajectory point repeats Step S202 to output the temporary sampling direction for the corresponding number of times. When the predetermined number of recursive samplings is reached, the last output temporary displacement, i.e., the temporary sampling direction, is used as the movement direction to the next trajectory point and the sampling direction of the next trajectory point.

For the initial point O, the image block obtained by cropping the sampling region formed by the initial point O is input into a pre-trained deep learning model. This model outputs a temporary sampling direction, and the sampling direction of the sampling region corresponding to the current trajectory point is adjusted to be consistent with the temporary sampling direction (such as the temporary direction F1 shown in FIG. 2).

It's important to note that at the initial point, there is no previous displacement, so the sampling direction of the initial sampling region will be randomly selected from 0 to 360 degrees, for example, the sampling direction as F₀, as shown in FIG. 2.

For trajectory points other than the initial point, when the navigation agent moves to the position of the current trajectory point, it first moves along the direction of the previous displacement Pₜ₋₁ to Pₜ. This displacement is denoted as vₜ₋₁, which means the distance from Pₜ₋₁ to Pₜ. In this step, an image block is cropped from the sampling region EFGH as shown in FIG. 3. This image block corresponds to a square region centered at this point, containing the image information within that region.

When the cropped image block corresponding to the sampling region EFGH is input into the pre-trained deep learning model, it generates a temporary displacement (∂x, ∂y), which represents a temporary sampling direction f₁ (as shown in FIG. 3). The current sampling direction F₂ is then adjusted to match the temporary sampling direction f₁, forming a new sampling region E′F′G′H′. The image block corresponding to this new sampling region E′F′G′H′ is cropped from the original image for further processing.

This process is repeated for the current trajectory point according to Step S202, looping until the specified recursion count (i.e., the predetermined number of iterations) is reached. Once the loop ends, the last generated temporary displacement, i.e., the temporary sampling direction, is used as the movement direction for proceeding to the next trajectory point and as the sampling direction for that point. It's important to note that this temporary displacement is not used to physically move the navigation agent; rather, it guides the sampling direction for subsequent steps.

A deep learning model is built using a CNN network model, trained using a training dataset that includes annotated cardiac MRI images with the left ventricle labeled, chest X-ray images with the heart labeled, and dermatoscope images with moles labeled. This process results in obtaining a pre-trained deep learning model.

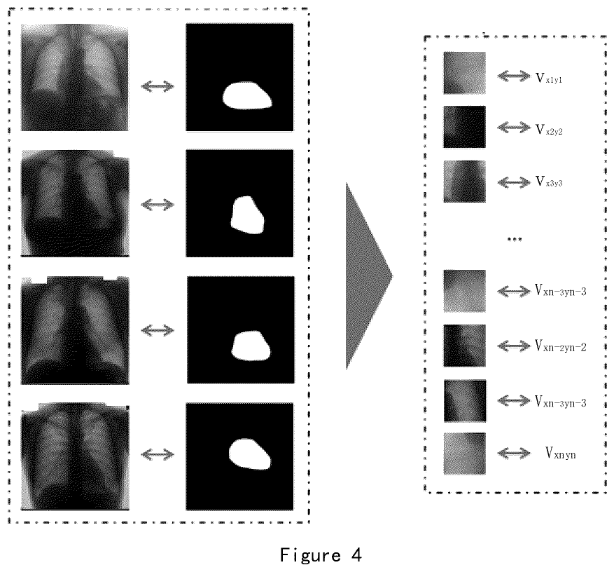

In this example, the annotated images (specifically including annotated chest images and dermatoscope images with the target to be segmented) are all grayscale images with the segmented targets labeled. These grayscale images are transformed into a dynamic field system with a limit cycle, which is a vector field. The resolution of the vector field (mesh density) is the same as the resolution of the grayscale images. In the grayscale images corresponding to the annotated images, each position corresponds to a unique vector in the vector field. Each image block in the sampling regions (e.g., the rectangular region ABCD corresponding to the initial sampling region in FIG. 2) corresponds to a vector, such as displacement vectors v_{x1y1}, v_{x2y2}, v_{x3y3} . . . v_{xn-3yn-3}, v_{xn-2yn-2}, v_{xn-1yn-1}, v_{xnyn}, on the grayscale image of the processed image, and each image block in the sampling region corresponds to a vector. The specific correspondence can be seen in FIG. 4.

The annotated images (specifically including annotated chest images and dermatoscope images with the target to be segmented) include a matching correspondence between image blocks and vectors. Sampling operations are performed on the same region of interest in the processed image at each time step (for example, containing the left ventricle, heart, melanocytic nevi, etc.), and based on the aforementioned matching correspondence, displacement vectors corresponding to each sampling region are determined to constitute the training dataset for training the deep learning model.

The network structure of the deep learning model includes an input layer, five convolutional layers, five pooling layers, a fully connected layer, and an output layer. Refer to Table 1 below for specifics.

TABLE 1

| | Input | Output | Filter | |
|---|---|---|---|---|
| | Channel | Channel | Size | Padding |
| Convolutional layer1_1 | 1 | 16 | 3 × 3 | 2 |
| Convolutional layer 1_2 | 16 | 32 | 3 × 3 | 2 |
| Max pooling layer 1 | | | 2 × 2 | |
| Convolutional layer 2_1 | 32 | 64 | 3 × 3 | |
| Convolutional layer 2_2 | 64 | 64 | 3 × 3 | |
| Max pooling layer 2 | | | 2 × 2 | |
| Convolutional layer 3_1 | 64 | 128 | 3 × 3 | 1 |
| Convolutional layer 3_2 | 128 | 128 | 3 × 3 | 1 |
| Max pooling layer 3 | | | 2 × 2 | |
| Convolutional layer 4 1 | 128 | 256 | 3 × 3 | 1 |
| Convolutional layer 4_2 | 256 | 256 | 3 × 3 | 1 |
| Max pooling layer 4 | | | 2 × 2 | |
| Convolutional layer 5 | 256 | 512 | 3 × 3 | 1 |
| Fully connected layer 1 | 8192 | 2048 | | |
| Fully connected layer 2 | 2048 | 2048 | | |
| Output layer | 2048 | 2(for x, y) | | |

For the input layer, the size of the input image blocks (patches), such as the output image block (region obtained after sampling), is 64×64×3 for RGB images, for example, dermatoscope images.

Similarly, for grayscale images like cardiac MRI images or chest X-ray images, the size of the input image block (patch) is 64×64×1.

Regarding the fully connected layer, it contains 4096 neurons. As for the output layer, it has been modified to include two neurons, for example, representing the output displacement (∂x, ∂y), which signifies the sampling displacement direction.

Table 1 illustrates an example of the relevant parameters for the network structure of the deep learning model in this invention.

Training the deep learning model with the aforementioned training dataset allows the pretrained model to learn the matching correspondence between the “navigation agent” and the displacement of the target to be segmented, resulting in a well-trained pretrained deep learning model.

Following the training process with the mentioned model, the trained model will guide the “navigation agent” to move on the aforementioned medical images. This movement occurs step by step, where the navigation agent, based on the image block information from a directional square area around the current trajectory point, provides the displacement from the current trajectory point to the next step. For instance, this can be represented as vₜ (here, t=1,2,3,4 . . . n, n is a positive integer, and t represents which step it is).

Further, when the specified number of times is set to C, the sampling direction of each trajectory point on the processed image is corrected C times. This is achieved using the following expression to calculate the real-time correction displacement between the current time step t and the time step t−i, in order to determine the deviation of each sampling, which is then used to correct each sampling direction:

$${CDO}_{t} = S ( C ) {\sum }_{i = 1}^{n} {( 1 - S ( C ) )}^{i - 1} Δ {v}_{t - i} \qquad ( 1 )$$

Where CDOₜ represents the corrective displacement difference required for the navigation agent to move from the current trajectory point at time step t on the processed image to the next trajectory point, where t represents the current time step; S(C) is a sigmoid function with a logarithmic term, defined as

$$S ( C ) = \frac{1}{1 + {e}^{log ( C )}} ,$$

used to characterize the weight at each time step, where C represents the number of samples in recursive sampling at the same trajectory point; vₜ is the displacement at time step t or the current time step, vₜ₋ᵢ represents the displacement at time step t−i, where i is a positive integer denoting the number of steps backward from the current time step t; Δvₜ₋ᵢ represents the difference between vₜ₋ᵢ and vₜ₋ᵢ₋₁.

By calculating the corrective displacement difference between the current time step t and time step t−i, this information is used to correct the displacement of the current trajectory point at time step t. This process yields the corrected displacement for each trajectory point. The navigation agent moves on the processed image to generate each trajectory point until the cutting trajectory containing the target to be segmented is generated.

Based on the segmentation accuracy results obtained from multiple experiments, the following are the recommended recursive sampling iterations (C) for different medical image scenarios:

For chest X-ray images, C is preferred to be 15 iterations within the range of 5 to 20 iterations.

For cardiac MRI images, C is preferred to be 15 iterations within the range of 5 to 20 iterations.

For dermatoscopy images, C is preferred to be 15 iterations within the range of 10 to 20 iterations.

The recursive sampling iterations mentioned earlier were determined through multiple experiments. Initially, a range of values was established, and then based on the segmentation accuracy corresponding to each parameter, the optimal number of iterations or the optimal range of iterations for recursive sampling was determined. Additionally, to ensure that the pre-trained deep learning model accurately predicts the displacement from each current trajectory point to the next, adjustments are made multiple times using the pre-trained model's output. This correction process occurs each time the navigation agent reaches a new trajectory point, forming a loop that adjusts the displacement for the same trajectory point. The number of iterations in this loop is specifically adjusted based on the application scenarios of different medical images.

In the second implementation method, the following expression is used to calculate the exponential moving average of the current time step t and time step t−i in real-time. This is used as the correction displacement difference required for the current trajectory point to move to the next trajectory point, in order to determine the deviation of each sampling and correct the sampling direction accordingly.

$${EMA}_{t} = η {\sum }_{i = 1}^{n} {( 1 - η )}^{i - 1} Δ {v}_{t - i} \qquad ( 2 )$$

EMAₜ represents the exponential moving average of the correction displacement difference required for the navigation agent to move from the current trajectory point at time step t to the next trajectory point on the processing image, where t denotes the current time step. η represents the weight corresponding to different time steps. vₜ represents the displacement at time t or the current time step, while vₜ₋ᵢ represents the displacement at time step t−i, where i is a positive integer indicating the number of steps backward from the current time step t. Δvₜ₋ᵢ represents the difference between vₜ₋ᵢ and vₜ₋ᵢ₋₁.

Optionally, η is in the range of 0.4 to 0.9.

To calculate the correction displacement required for the current trajectory point to move to the next trajectory point using the second implementation method, it is necessary to determine the weight η corresponding to different time steps and the recursive sampling frequency corresponding to different application scenarios of medical images.

The adjustments made to the recursive sampling frequency and the weights corresponding to different time steps mentioned above are obtained through multiple experiments. This involves defining a range of values and then determining the optimal frequency or range for the recursive sampling based on the segmentation accuracy corresponding to each parameter. Similarly, the optimal values or range for the weights corresponding to different time steps are determined based on the segmentation accuracy. Additionally, to ensure that the pre-trained deep learning model accurately predicts the displacement from the current trajectory point to the next trajectory point at each time step, adjustments are made using the pre-trained deep learning model's output. This iterative process of recursive sampling for the same trajectory point is tailored specifically for different application scenarios in medical images.

In the third implementation approach, sampling operations are performed within each time step, with one sampling operation corresponding to one time step. The navigation agent navigates on the input image to create a trajectory point at each time step.

Specifically, the process involves extracting the image (image block) from the corresponding area of the initial sampling region in the input image. This extracted image block is then fed into the pre-trained deep learning model to output the direction vector F1 for the second sampling operation (i.e., the next sampling operation). The initial sampling direction on the input image is adjusted to F₁, thus determining the displacement direction or movement direction F₁ for the current time step t corresponding to the second sampling operation (i.e., the next sampling operation). For example, taking a 64×64 square area as the initial sampling region, the orientation of this square area corresponds to the displacement at the corresponding position in the vector field. The image block from this square area along with the determined displacement vector is then saved.

Specifically, after the sampling direction F₁ undergoes displacement correction processing (also referred to as correction processing), the corrected sampling direction F₁′ is obtained. This corrected sampling direction F₁′ is then used to guide the execution of the next sampling operation based on the determined sampling direction F₁′. The process continues as follows: the sampling direction F₁′ is used to extract the corresponding area in the input image, which is then fed into the pre-trained deep learning model to output the displacement direction or movement direction F₂ for the third sampling operation. The sampling direction F₂ is then subjected to displacement correction processing to obtain the corrected sampling direction F₂′, which is used to guide the execution of the next sampling operation based on the determined sampling direction F₂′. This process repeats for subsequent sampling operations, with each sampling direction F₃, F₄, and so on, undergoing displacement correction processing to obtain the corrected sampling directions F₃′, F₄′, and so forth, guiding the execution of each subsequent sampling operation.

Next, the sampling operations are performed sequentially to determine the sampling direction for the next displacement based on the movement direction at the current time step, continuing until a cutting trajectory containing the target to be segmented is generated.

In the first, second, and third implementation methods, the process of generating a cutting trajectory containing the target to be segmented is determined based on convergence criteria.

Specifically, the convergence criteria include determining detection lines. During the generation process of the cutting trajectory containing the target to be segmented, interval lines are formed based on the intersection points between the generated trajectory lines and the detection lines. These interval lines are then compared to a preset distance to determine if the process of generating a cutting trajectory containing the target to be segmented is complete.

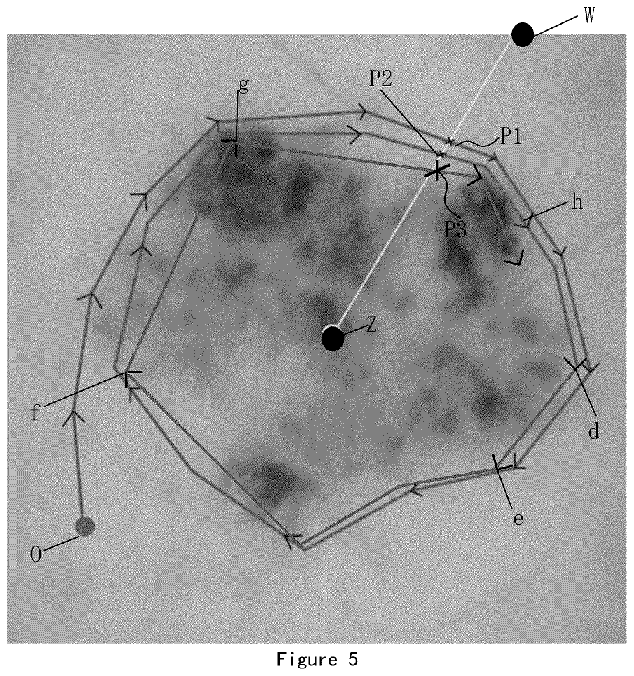

FIG. 5 is a schematic diagram of an example of completion of generating cutting trajectories for segmenting targets in a dermatoscope detection image using the method of image segmentation control according to the present disclosure. The following will be combined with the example in FIG. 5 to explain how the convergence criteria are used to determine if the process of generating the cutting trajectory containing the target to be cut has been completed, based on the example in FIG. 5.

As shown in FIG. 5, on the image to be processed, starting from the initial point O, sequentially generate each trajectory point to form a trajectory line. Specifically, connect the image center Z of the image to be processed with any point on any edge line of the image to be processed to form a detection line. This detection line is used to form interval lines with the intersection points of the generated trajectory lines, further used for comparing and judging against the preset distances.

Due to the anatomical structure of the target to be segmented on the image being a closed, elliptical region (such as the heart in chest X-rays, the left ventricle in cardiac MRI, and moles in dermatoscopy detection images), and typically located in the central area of the image, a straight line is formed by connecting a point in the center of the image and any point on the image's boundary line to act as a detection line.

Following the sampling process described above, trajectory points and lines are generated sequentially, and the intersections between the generated trajectory lines and the detection line are recorded. For example, intersections P₁, P₂, and P₃ are noted. The interval line formed based on the last two intersections (e.g., interval line P₂P₃) is then compared to a predetermined distance. Specifically, when the interval line (e.g., interval line P₂P₃) is less than the predetermined distance, it is determined that the convergence criteria are met, and the process of generating the cutting trajectory containing the target to be cut is completed. Conversely, when the interval line (e.g., interval line P₂P₃) is greater than the predetermined distance, it is determined that the convergence criteria are not met, and the process of generating the cutting trajectory containing the target to be cut is not completed. In such cases, sampling and trajectory generation operations continue until the convergence criteria are met, thereby determining the completion of the cutting trajectory generation process containing the target to be cut, such as the completion of generating the cutting trajectory for the left ventricle and heart.

Understood, there is no specific limit on the number of intersection points. In other implementation methods, there could be 8, 9, or even more intersection points. The examples provided earlier are just for illustration purposes and should not be seen as limitations on the invention.

Additionally, to avoid infinite loops in the algorithm of the pre-trained deep learning model, the maximum step length for the navigation agent's movement is adjusted to a specific value, such as 10,000 steps. To adapt to different application scenarios of medical images, adjustments are made to the preset distance in the convergence criteria mentioned earlier.

When the navigation agent crosses the detection line for the first time, it begins to observe the intersection between the navigation agent's movement on the image and the detection line. If the interval line formed by the intersections of the current and previous two intersections is within the specified range of the preset distance (for example, a specified range of 2-10 pixel distances, which can be calculated directly using 2D Euclidean distance due to significant differences in image resolutions in different application scenarios), the navigation agent stops moving. Based on the intersection information, the trajectory line of the agent between the last two intersections on the detection line is determined and retained as the cutting trajectory for the target to be segmented.

Specifically, in the case of the left ventricle as the target for segmentation, the preset distance in the aforementioned convergence criteria (specifically in preset pixels) is set to 2.

For the heart as the target for segmentation, the preset distance in the aforementioned convergence criteria (specifically in preset pixels) is set to 5.

For the mole as the target for segmentation, the preset distance in the aforementioned convergence criteria (specifically in preset pixels) is set to 10.

By adjusting the preset distance in the convergence criteria for different medical images, it is possible to optimize the pre-trained deep learning model and obtain more accurate trajectories for the target to be segmented. This can further improve the segmentation accuracy.

In a specific implementation, when applying the trained deep learning model (i.e., pre-trained deep learning model), the input is a sampling area of, for example, a dermatoscope detection image. The output is the displacement corresponding to the center point of this sampling area (initial point, each trajectory point that the navigation agent will generate), specifically including the process of recursive sampling to obtain the corrected displacement of each trajectory point. This process leads to the generation of the cutting trajectory containing the target to be segmented (as shown by the trajectory line P2hdefgP3 in FIG. 5).

Please note that the above is provided as an optional example and should not be construed as a limitation on the invention.

In step S103, the deviation of each sampling is determined in real-time based on the generated trajectory points and the corresponding sampling regions of each sampling operation. This is done to correct each sampling direction, optimizing the generated cutting trajectory on the image being processed.

Specifically, the deviation of each sampling is calculated in real-time using exponential moving averages to correct each sampling direction.

In the first implementation method, the correction displacement CDOₜ calculated based on the current trajectory point at time step t is used to correct the displacement (also referred to as movement direction or sampling direction) from the current trajectory point to the next trajectory point.

$${v}_{t}^{′} = {v}_{t} + {CDO}_{t} \qquad ( 3 )$$

Where vₜ represents the displacement from the current trajectory point to the next trajectory point; vₜ′ represents the corrected displacement corresponding to the next trajectory point from the current trajectory point; and CDOₜ represents the correction displacement offset required for the navigation agent at the current time step t in the image to move from the current trajectory point to the next trajectory point, with t denoting the current time step.

Using the first implementation method, calculating the correction displacement required for the current trajectory point to move to the next trajectory point only requires determining the recursive sampling times corresponding to different medical image application scenarios, without the need to determine the weights f corresponding to different time steps. In the case of the same computational load, this can further optimize the calculation process and improve the accuracy of image segmentation.

By correcting the displacement from the current trajectory point to the next trajectory point based on the calculated correction displacement offset CDOₜ for the current time step, and adjusting the recursive sampling times based on different medical image applications, more accurate target trajectory can be obtained, leading to further improvement in segmentation accuracy.

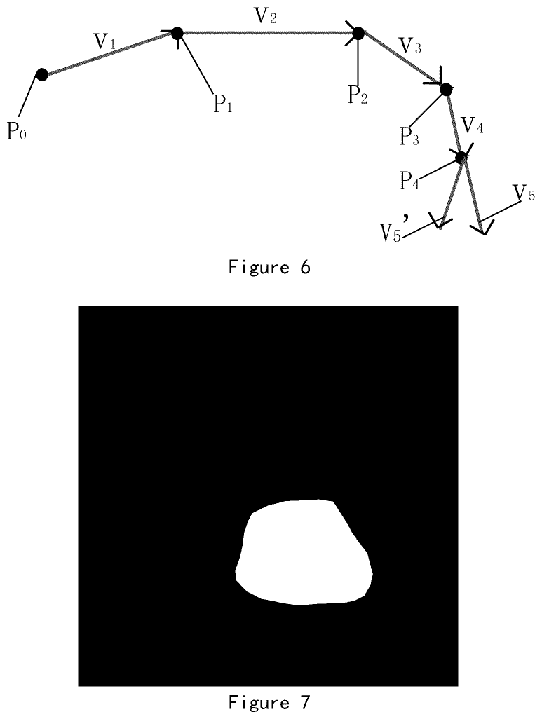

FIG. 6 is an illustrative diagram of an example of calculating the corrective displacement required for the current trajectory point to move to the next trajectory point in the first implementation method of the medical image target segmentation trajectory generation method of the present disclosure.

As shown in FIG. 6, the displacement between p0 and p1 is v1, between p1 and p2 is v2, between p2 and p3 is v3, and between p3 and p4 is v4. The predetermined number of recursive samples is C=10. At the current time step t=4, with the current trajectory point being p4, use the above formula (1) to calculate CDO₄, and further calculate the displacement v4 for the next trajectory point p5.

$${CDO}_{4} = \frac{1}{1 + {e}^{- log ( 10 )}} {\sum }_{i = 1}^{n = 4} {( 1 - S ( 10 ) )}^{i - 1} Δ {v}_{4 - i} = ( \frac{1}{1 + {e}^{- log ( 10 )}} ) Δ {v}_{3} + {( \frac{1}{1 + {e}^{- log ( 10 )}} )}^{2} Δ {v}_{2} + {( \frac{1}{1 + {e}^{- log ( 10 )}} )}^{3} Δ {v}_{1} + {( \frac{1}{1 + {e}^{- log ( 10 )}} )}^{4} Δ {v}_{0}$$

Next, using the above expression (3), vₜ=vₜ+CDOₜ, calculate vₜ′.

According to the second implementation method, calculate the displacement vₜ₊₁ corresponding to the movement from the current trajectory point to the next trajectory point based on the previously generated displacement vₜ and the computed exponential moving average EMAₜ.

$${v}_{t}^{′} = {v}_{t} + {EMA}_{t} \qquad ( 4 )$$

Where vₜ represents the displacement from the current trajectory to the next trajectory point; vₜ′ represents the corrected displacement corresponding to the movement from the current trajectory point to the next trajectory point; EMAₜ represents the corrective displacement difference needed for the navigation agent to move from the current trajectory point to the next trajectory point on the image being processed at the current time step t.

Using the second implementation method, calculate the corrective displacement needed for the current trajectory point to move to the next trajectory point. Given a segment of the trajectory line [p0p1p2p3p4], where the displacements between p0 and p1, p1 and p2, p2 and p3, p3 and p4 are known as v1, v2, v3, and v4 respectively, at the current time step t=4 with the current trajectory point being p4, use the above expression (2) to calculate EMA₄, and further compute the displacement v4 for the next trajectory point p5.

Given that Δv₁=v₁−v₀, Δv₂=v₂−v₁, Δv₃=v₃−v₂, η=0.7, the current time step t=4 with the current trajectory point being p4, the corrective EMA_4 needed for displacement v4 can be calculated as follows:

$${EMA}_{4} = 0.7 \times {\sum }_{i = 1}^{4} {( 1 - 0.7 )}^{i - 1} Δ {v}_{4 - i} = 0.7 \times Δ {v}_{3} + {( 0.3 )}^{1} \times Δ {v}_{2} + {( 0.3 )}^{2} \times Δ {v}_{3} .$$

For the correction of the displacement v4 to reach the next trajectory point p5, it is specifically expressed as: v₄=v₄+EMA₄.

In this example, for the mentioned image to be processed, f is determined within the range of 0.4 to 0.9 based on parameters such as image type, shape and size of the target to be segmented, and image resolution.

Specifically, for a cardiac MRI image with the target being the left ventricle, f is in the range of 0.7 to 0.9, with an optimal value of 0.8.

For a chest X-ray image with the target being the heart, f is in the range of 0.4 to 0.6, with an optimal value of 0.5.

For a dermatoscope detection image with the target being a mole, η is in the range of 0.5 to 0.7, with an optimal value of 0.6.

Next, in step S104, the image will be segmented based on the optimized cutting trajectory to obtain the target image containing the segmented target.

Specifically, based on the optimized cutting trajectory from Step S103, perform image segmentation on the image to obtain the target image containing the region to be cut (for example, in FIG. 7, the white area on a black background represents the region to be cut, and the boundary line between the white area and the black background is the cutting trajectory line).

Noted, the examples provided are for illustrative purposes and should not be construed as limitations to the invention. Additionally, the figures serve as schematic representations of the processing involved in exemplary embodiments of the present disclosure, and they do not imply or restrict the chronological order of these processes. It is also understood that these processes can be executed synchronously or asynchronously, for instance, across multiple modules.

To validate the technical efficacy of the present disclosure, ablative experiments are conducted. These experiments involve gradually removing or modifying certain components within the same system (comprising multiple modules) and observing the impact on model performance. Specifically, the performance of three methods is compared: the existing method (e.g., DPM method), the first implementation method (recursive sampling for each trajectory point, calculating CDOₜ to correct the displacement of each trajectory point), and the second implementation method (recursive sampling for each trajectory point, calculating EMAₜ to correct the displacement of each trajectory point). These comparisons are performed across three application scenarios (chest X-ray images, cardiac MRI images, dermatoscope detection images) using a common test dataset from publicly available data sources. Additionally, this dataset includes standard segmentation results, which are grayscale images annotated by domain experts and having the same resolution as the corresponding images (saved in black and white format, where black represents the background and white represents the segmented target area).

The segmentation accuracy of the trajectories generated by the three methods is compared using annotated images, typically measured using the average Dice coefficient. For the existing method, the segmentation accuracy of the generated trajectories ranges from 0.892 to 0.901. Using the first implementation method of the invention yields segmentation accuracy ranging from 0.914 to 0.951, while the second implementation method results in segmentation accuracy ranging from 0.910 to 0.931. It is evident that both implementations of the present disclosure achieve significantly higher segmentation accuracy compared to the existing method. Therefore, employing the methods of the present disclosure leads to a substantial improvement in segmentation accuracy for the trajectories.

It should be noted that the consistency comparison standard used for segmentation target regions is typically the mainstream evaluation criterion DICE. The DICE coefficient ranges from 0 to 1, where a Dice value of 1 indicates perfect agreement between the segmented target trajectory estimated using this method and the target region in the standard image provided by relevant professionals. A Dice value of 0 indicates complete inconsistency or no intersection between the two regions. As shown in Table 1, comparing segmentation accuracy reveals that both the first and second implementation methods of the present disclosure significantly outperform the existing method.

Through grid search on these two parameters, the optimal parameter combinations yielding the highest average Dice coefficient can be obtained for each medical imaging scenario. Specifically, for the scenario where the target to be segmented is the left ventricle, η is set to 0.8, and the predetermined number of recursive sampling iterations C is set to 15. In the case of the heart being the target, η is set to 0.5, with C also set to 15 iterations. Similarly, for the scenario involving the segmentation of a pigmented mole, η is set to 0.6, and C remains at 15 iterations.

Compared to existing techniques, this invention improves segmentation accuracy by selecting the initial point of the image to be processed and using it as the starting point for the navigation agent. The navigation agent is then guided to generate trajectory points starting from this initial point until a segmentation trajectory containing the target to be segmented is formed. This process involves real-time determination of deviations during each sampling operation based on the generated sampling areas, correcting each sampling direction to optimize the resulting segmentation trajectory while generating it on the image to be processed. The optimized segmentation trajectory is then used to segment the image and obtain the target image containing the segmented target. This approach not only enhances segmentation accuracy by optimizing the segmentation trajectory but also addresses the issue of low segmentation accuracy caused by cumulative errors resulting from the difference between discrete and continuous systems introduced by neural network methods.

Additionally, this invention employs recursive sampling for each trajectory point on the image to be processed, meaning the same trajectory point is sampled a predetermined number of times. Based on the current trajectory point corresponding to the current time step and the calculated correction displacement, corrections are made to the displacement (i.e., movement direction or sampling direction) from the current trajectory point to the next trajectory point. By adjusting the predetermined number of recursive samples tailored to different medical images, more accurate trajectory points for the target to be segmented can be obtained, further enhancing segmentation accuracy.

Furthermore, adjusting the preset distance of convergence conditions for different medical images can improve segmentation accuracy while optimizing the pre-trained deep learning model.

### Example 2

The following is an embodiment of the apparatus of the present disclosure, which can be used to execute the method examples of the present disclosure. For details not disclosed in this implementation example of the device of the present disclosure, please refer to the method examples of the present disclosure.

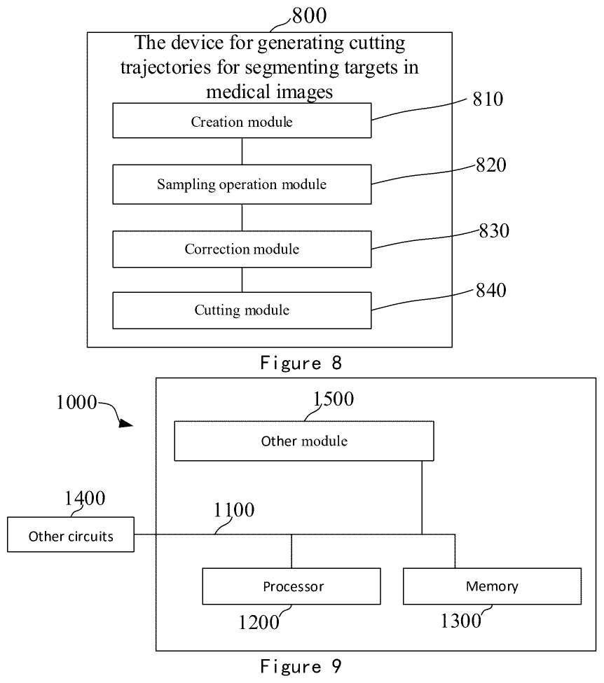

FIG. 8 is a structural schematic diagram of an example of the medical image segmentation trajectory generation device according to the present disclosure.

Referring to FIG. 8, the present disclosure provides a medical image segmentation trajectory generation apparatus 700, which employs the medical image segmentation trajectory generation method described in the first aspect of the present disclosure.

The medical image segmentation trajectory generation device 800 includes a creation module 810, a sampling operation module 820, a correction module 830, and a segmentation module 840.

In a specific implementation, the creation module 810 acquires the target image for processing, which includes chest X-ray images and dermatoscope detection images, containing target structures relevant to medical anatomy. The sampling operation module 820 selects the initial point of the target image and begins sampling operations with the initial point as the starting point, using the initial sampling area generated from the initial point until a segmentation trajectory containing the target to be segmented is generated. Each sampling operation's resulting sampling area is inputted into a pre-trained deep learning model to determine the sampling direction for the next time step based on the current time step's movement direction, guiding the next time step's sampling operation accordingly. The correction module 830 calculates the deviation of each sampling operation in real-time based on the generated sampling areas corresponding to each sampling operation, using exponential moving averages to correct the sampling direction of each sampling operation, optimizing the generated segmentation trajectory while generating the segmentation trajectory on the target image. The segmentation module 840 segments the target image based on the optimized segmentation trajectory to obtain the target image containing the segmented target.

According to the optional embodiment, the initial point of the target image is selected, and recursive sampling is performed on this initial point with a predefined number of correction iterations. This process yields the corrected displacement corresponding to the corrected initial point. Specifically, this involves conducting sampling operations on the initial point for a predefined number of times and adjusting the sampling direction of the initial sampling area formed based on the initial point for a predefined number of times to obtain the corrected sampling direction of the initial sampling area. For each trajectory point that will be formed on the target image, recursive sampling is performed with a predefined number of correction iterations, resulting in the corrected displacement corresponding to each trajectory point.

According to the optional implementation method, when the preset count is C, the sampling direction of each trajectory point on the image to be processed is corrected C times. The following expression is used to calculate the correction displacement difference between the current time step t and time step t−i:

$${CDO}_{t} = S ( C ) {\sum }_{i = 1}^{n} {( 1 - S ( C ) )}^{i - 1} Δ {v}_{t - i}$$

Where CDOₜ represents the corrective displacement difference needed for the navigation agent to move from the current trajectory point at time step t to the next trajectory point on the image to be processed, where t represents the current time step; S(C) is a sigmoid function with a logarithm, defined as

$$S ( C ) = \frac{1}{1 + {e}^{log ( C )}} ,$$

used to
   characterize the weight at each time step, where C denotes the sampling count for recursive sampling at the same trajectory point; vₜ is the displacement at time t or the current time step, vₜ₋ᵢ represents the displacement at time step t−i, where i is a positive integer indicating the number of steps backward from the current time step t; Δvₜ₋ᵢ denotes the difference between vₜ₋ᵢ and vₜ₋ᵢ₋₁.

According to the optional implementation, for chest X-ray images, the preferred range for the recursive sampling count C is between 5 and 20 times, with an optimal choice of 15 times. For cardiac MRI images, the preferred range for the recursive sampling count C is also between 5 and 20 times, with an optimal choice of 15 times. For dermatoscope images, the preferred range for the recursive sampling count C is between 10 and 20 times, with an optimal choice of 15 times.

According to the optional implementation, adjust the displacement from the current trajectory point to the next trajectory point based on the current trajectory point corresponding to the current time step t and the calculated correction displacement difference CDOₜ.

$${v}_{t}^{′} = {v}_{t} + {CDO}_{t}$$

vₜ represents the displacement from the current trajectory point to the next trajectory point; vₜ represents the corrected displacement corresponding to the current trajectory point to the next trajectory point; CDOₜ denotes the correction displacement difference required for the navigation agent from the current trajectory point to the next trajectory point on the image being processed at the current time step t, where t indicates the current time step.

According to the optional implementation, it further includes the following steps for recursive sampling:

Step S201: When the navigation agent moves to the current trajectory point, the agent first moves along the direction of the previous displacement, based on the displacement of the previous trajectory point, to extract the image block corresponding to the sampling area from the image being processed.

Step S202: The extracted image block corresponding to the sampling area is inputted into a pre-trained deep learning model, which outputs a temporary sampling direction. The sampling direction of the current trajectory point is adjusted to match the temporary sampling direction.

Step S203: Depending on the recursive sampling count, Step S202 is iteratively executed for the current trajectory point to output the temporary sampling direction multiple times. When the specified number of recursive samplings is reached, the last outputted temporary displacement, i.e., the temporary sampling direction, is used as the movement direction towards the next trajectory point and the sampling direction for the next trajectory point.

According to the optional embodiment, it further includes: determining whether the generation process of the cutting trajectory containing the target to be cut has been completed based on convergence criteria. The convergence criteria include determining a detection line. During the generation process of the cutting trajectory containing the target to be cut, an interval line is formed based on the intersection points between the generated trajectory line and the detection line. The drawn interval line is further compared with a preset distance to determine whether the generation process of the cutting trajectory containing the target to be cut has been completed.

Additionally, according to the optional implementation, it also includes calculating the displacement vₜ₊₁ corresponding to the movement from the current trajectory point to the next trajectory point based on the previously generated displacement vₜ and the calculated exponential moving average EMAₜ.

$${v}_{t}^{′} = {v}_{t} + {EMA}_{t}$$

Where vₜ represents the current trajectory's displacement to the next step; vₜ′ represents the corrected displacement corresponding to the movement from the current trajectory point to the next trajectory point; EMAₜ represents the correction displacement difference required for the current trajectory point at the current time step t on the image to be processed. It's important to note that in the example of FIG. 8, the method for generating cutting trajectories of medical image targets performed by the medical image target cutting trajectory generation device is largely similar to the content of the medical image target cutting trajectory generation method shown in FIG. 1, therefore, explanations for the identical parts are omitted.

Compared to existing techniques, this invention improves segmentation accuracy and addresses cumulative errors resulting from discrepancies between discrete and continuous systems introduced by neural network methods. This is achieved by selecting the initial point of the image to be processed and using it as the starting point for the navigation agent. The navigation agent is then guided to generate trajectory points until a cutting trajectory containing the target to be segmented is created. Based on the sampled regions corresponding to each sampling operation, deviations are promptly determined to correct the sampling direction in real-time. This optimization of the cutting trajectory enhances segmentation accuracy while ensuring the generation of a target image containing the segmented target on the processed image.

Additionally, this invention improves segmentation accuracy by recursively sampling each trajectory point on the processed image (i.e., sampling a predetermined number of times at the same trajectory point). Based on the current trajectory point corresponding to the current time step and the calculated correction displacement, the invention corrects the displacement from the current trajectory point to the next trajectory point (i.e., the movement or sampling direction). Furthermore, by adjusting the predetermined number of recursive samples tailored to different medical images, this approach enables obtaining a more precise trajectory of the target to be segmented, thereby further enhancing segmentation accuracy.

Additionally, as shown in FIG. 9, the invention includes electronic equipment corresponding to the medical image target segmentation trajectory generation device. The electronic device 1000 comprises a processor 1200, a memory 1300, and other circuits 1400. The memory 1300 stores a computer-executable program, typically in the form of machine-readable code. The computer-readable program can be executed by the processor 1200, enabling the electronic device to perform the method of the present invention or at least some steps of the method. Additionally, The electronic device 1000 comprises other module 1500.

The memory 1300 includes volatile memory such as random access memory (RAM) and/or cache memory units, and may also include non-volatile memory such as read-only memory (ROM).

Optionally, in this embodiment, the electronic device also includes an I/O interface for data exchange between the electronic device and external devices. The I/O interface can represent one or more types of bus structures, including memory unit buses or controllers, peripheral buses, graphics acceleration ports, processing unit buses, or local buses using various bus structures.

Those in the technical field can understand that the aforementioned modules can be distributed throughout the device according to the description of the embodiments, or can be modified correspondingly in one or more devices that are different from this embodiment. The modules in the embodiments mentioned above can be combined into one module or further split into multiple sub-modules.

Based on the description of the embodiments above, technical personnel in this field can easily understand that the example embodiments described here can be implemented through software or in combination with necessary hardware. Therefore, the technical solution of the embodiments of the present invention can be embodied in the form of a software product, which can be stored in a non-volatile storage medium (such as a CD-ROM, USB flash drive, external hard drive, etc.) or on the network, including several commands to enable a computing device (such as a personal computer, server, mobile terminal, or network device, etc.) to execute the method according to the embodiments of the present invention.

The specific examples provided above illustrate the exemplary embodiments of the present invention. It should be understood that the present invention is not limited to the detailed structures, configurations, or implementation methods described here; instead, the present invention is intended to encompass various modifications and equivalent arrangements within the spirit and scope of the appended claims.

1. A method for generating a cutting trajectory of a medical image for a target to be cut, comprising:
obtaining an image to be processed, wherein the image to be processed comprises chest X-ray images, cardiac MRI images and dermatoscope detection images, and the image to be processed contains the target to be cut with relevant medical anatomical structures;
selecting an initial point of the image to be processed;
using the initial point as a starting point of a navigation agent;
guiding the navigation agent to generate trajectory points until the cutting trajectory containing the target to be cut is generated, comprising:
performing sampling operations for each trajectory point to obtain a sampling area;
inputting the obtained sampling area into a pre-trained deep learning model to obtain a displacement from each trajectory point to a next trajectory point; and
allowing the navigation agent to generate continuous trajectory points to include the cutting trajectory of the target to be cut;
calculating, at real-time, a deviation for each sampling operation based on the generated trajectory points and a corresponding sampling area;
correcting a sampling direction to optimize the cutting trajectory generated, while generating the cutting trajectory on the image to be processed; and
cutting the image to be processed according to the optimized cutting trajectory to obtain a target image containing the target to be cut.

2. The method according to claim 1, further comprising:
after selecting the initial point of the image to be processed, performing a recursive sampling on the initial point for a predetermined number of times;
obtaining the displacement corresponding to the initial point after a correction, comprising:
performing the sampling operations on the initial point for the predetermined number of times; and
adjusting the sampling direction of an initial sampling area based on the initial point for the predetermined number of times to obtain a corrected sampling direction of the initial sampling area;
performing the recursive sampling for each trajectory point to be formed on the image to be processed for the predetermined number of times; and
obtaining the displacement corresponding to each trajectory point after the correction.

3. The method according to claim 2, further comprising:
correcting the sampling direction of each trajectory point on the image to be processed for C times, wherein:
C is a preset count, representing a number of sampling times in the recursive sampling at a same trajectory point; and
a correction displacement difference between a current time step t and a time step t−i is calculated using the following expression:
$${CDO}_{t} = S ( C ) {\sum }_{i = 1}^{n} {( 1 - S ( C ) )}^{i - 1} Δ {v}_{t - i}$$
wherein:
CDOₜ represents the correction displacement difference that the navigation agent needs to correct from a current trajectory point at the current time step t on an image being processed to the next trajectory point;
S(C) is a sigmoid function with a logarithmic term, defined as
$$S ( C ) = \frac{l}{1 + {e}^{log ( C )}}$$
and used to characterize a weight at each time step; and
Δvₜ₋ᵢ indicates a difference between vₜ₋ᵢ and vₜ₋ᵢ₋₁, wherein vₜ denotes the displacement at the current time step t, vₜ₋ᵢ represents the displacement at the time step t−i, and i is a positive integer denoting a number of steps backward from the current time step t.

4. The method according to claim 2, wherein a predefined number of the recursive sampling ranges from 5 to 20 times.

5. The method according to claim 4, wherein the predefined number of the recursive sampling is 15 times.

6. The method according to claim 2, further comprising:
correcting the displacement from a current trajectory point to the next trajectory point based on a current time step t corresponding to the current trajectory point and a computed correction displacement CDOₜ:
$${v}_{t}^{′} = {v}_{t} + {CDO}_{t}$$
wherein:
vₜ represents the displacement from the current trajectory point to the next trajectory point;
vₜ′ represents a corrected displacement from the current trajectory point to the next trajectory point; and
CDOₜ represents the computed correction displacement required for the navigation agent from the current trajectory point to the next trajectory point at the current time step t.

7. The method according to claim 2, wherein the performing the recursive sampling comprises:
moving the navigation agent along the sampling direction of a previous displacement first, when the navigation agent moves to a current trajectory point;
extracting, by the navigation agent, an image block corresponding to the sampling area from the image to be processed based on the displacement of a previous trajectory point;
inputting the extracted image block corresponding to the sampling area into a pre-trained deep learning model to output a temporary sampling direction;
adjusting the sampling direction of the current trajectory point's sampling area to match the temporary sampling direction;
depending on a recursive sampling count, processing the current trajectory point iteratively through the inputting and the adjusting, to output the temporary sampling direction a corresponding number of times; and
when a predetermined number of the recursive sampling is reached, using a last outputted temporary sampling direction as a movement direction to the next trajectory point and the sampling direction of the next trajectory point.

8. The method according to claim 1, further comprising:
based on convergence criteria, determining whether a process of generating the cutting trajectory containing the target to be cut has been completed, comprising:
determining detection lines for the convergence criteria;
in the process of generating the cutting trajectory containing the target to be cut, forming interval lines based on intersection points between generated trajectory lines and the detection lines; and
comparing the interval lines with a preset distance to determine whether the process of generating the cutting trajectory containing the target to be cut has been completed.

9. The method according to claim 1, further comprising:
calculating the displacement vₜ₊₁ from a current trajectory point to the next trajectory point based on a previous displacement vₜ and a computed exponential moving average EMAₜ:
$${v}_{t}^{′} = {v}_{t} + {EMA}_{t}$$
wherein:
vₜ represents the displacement from the current trajectory point to the next trajectory point;
vₜ′ represents a corrected displacement from the current trajectory point to the next trajectory point; and
EMAₜ represents a corrective displacement required by the navigation agent at a current time step t on the medical image corresponding to the current trajectory point.

10. A medical image target segmentation trajectory generation apparatus, comprising:
a creation module, configured to acquire an input image, which includes chest X-ray images, cardiac MRI images and dermatoscope detection images and contains target structures for medical dissection;
an sampling operation module, configured to:
select an initial point of the input image;
use the initial point as a starting point for a navigation agent to guide generating trajectory points until a cutting trajectory containing the target structures for medical dissection is generated;
perform sampling operations on each trajectory point to obtain sampling areas;
input the obtained sampling areas into a pre-trained deep learning model to obtain a displacement from each trajectory point to a next trajectory point; and
generate, for the navigation agent, continuous trajectory points to include the cutting trajectory of the target structures for medical dissection;
a correction module, configured to:
calculate, at real-time, a deviation of each sampling operation based on the generated trajectory points and corresponding sampling areas; and
correct a direction of each sampling operation to optimize the generated cutting trajectory while the cutting trajectory is generated on the input image; and
a cutting module, configured to segment the input image based on the optimized cutting trajectory to obtain a target image containing the target structures for medical dissection.

11. The medical image target segmentation trajectory generation apparatus according to claim 10, further comprising:
a selection module, configured to select the initial point of the input image and perform recursive sampling on the initial point for a predetermined number of times to obtain the displacement corresponding to a corrected initial point, wherein the selection module is further configured to:
perform the sampling operations on the initial point for the predetermined number of times; and
adjust a sampling direction of an initial sampling area based on the initial point for the predetermined number of times to obtain a corrected sampling direction of the initial sampling area; and
a recursive sampling module, configured to perform the recursive sampling for each trajectory point to be formed on the input image for the predetermined number of times to obtain the displacement corresponding to each corrected trajectory point.
